(19) United States
(12) Patent Application Publication
(10) Pub. No.: US 2011/0258409 A1
(43) Pub. Date: Oct. 20, 2011

(54) MEMORY DEVICE, HOST DEVICE, AND MEMORY SYSTEM

(75) Inventors: Munetake Ebihara, Kanagawa (JP); Hiroshi Kuno, Kanagawa (JP)

(73) Assignee: SONY CORPORATION, Tokyo (JP)

(21) Appl. No.: 13/081,690

(22) Filed: Apr. 7, 2011

(30) Foreign Application Priority Data
Apr. 16, 2010 (JP) P2010-095065

(51) Int. Cl. G06F 12/14

(52) U.S. Cl. 711/163; 711/E12.091

(57) ABSTRACT

A memory device is provided including: a storage section configured to store a content with a time limit for use; an elapsed time counting section configured to count the time limit; a battery section configured to be supplied with power from an external device accessing the time-limited content so as to be charged with power for operating the elapsed time counting section; and a control section configured to include a function of determining an expected time period during which the battery section can sustain the elapsed time counting section operating to count the time limit.

### CROSS REFERENCES TO RELATED APPLICATIONS

The present application claims priority to Japanese Patent Application JP 2010-095065 filed on Apr. 16, 2010, the entire contents of which is hereby incorporated by reference.

### BACKGROUND

The present disclosure relates to a memory device, a host device, and a memory system, the memory device storing time-limited contents such as those of which the uses are limited by DRM (Digital Rights Management) expiration dates.

The host device that reproduces the contents whose uses are limited by DRM expiration dates needs to access a secure clock by which to determine the time limit for use of a given content.

A networked PC or a TV set capable of radio wave reception can acquire a secure clock from servers, broadcasting stations, GPS stations, or satellites.

On the other hand, devices incapable of continuous network connection or of radio wave reception may set up an elapsed time counter that counts time following access to a secure clock. With the elapsed time counter allowed to count time thereafter without users' intervention, the device may determine the time limit for use of a given content.

### SUMMARY

The above-mentioned secure clock or the like that functions offline can be powered continuously and customized easily. For that reason, the clock is easy to mount additionally on a battery-equipped mobile reproduction device.

Meanwhile, typically on a mobile PC, it is difficult technically to ensure safety in counting time using software equivalent to a secure clock. It is also difficult for such mobile devices to customize and incorporate a piece of hardware equivalent to a secure clock due to cost constraints.

One possible solution to the above difficulties involves installing the secure clock in the form of external hardware. Candidates of such external hardware include stand-alone secure clock hardware products (e.g., USB secure clock dedicated devices) and secure clock-equipped removable media (e.g., hybrid products of USB memories and secure clock devices).

To design such external hardware may require preparing a power source (e.g., primary or secondary batteries, capacitors, etc.) with a sufficient capacity for counting time on a counter.

The power source (button cell or the like in the case of primary batteries) may pose problems if mounted on memory devices such as USB memories or Memory Sticks (registered trademark) due to cost or size constraints. Hence the need for a solution permitting the selection of a space-saving, less costly power source.

The present embodiments have been made in view of the above circumstances and provides a memory device, a host device, and a memory system capable of managing use time limit information unfailingly even by use of a minimum battery facility.

According to one embodiment, there is provided a memory device including: a storage section configured to store a content with a time limit for use; an elapsed time counting section configured to count the time limit; a battery section configured to be supplied with power from an external device accessing the time-limited content so as to be charged with power for operating the elapsed time counting section; and a control section configured to include a function of determining an expected time period during which the battery section can sustain the elapsed time counting section operating to count the time limit.

According to another embodiment, there is provided a host device including: a storage section configured to store time limit information and a content with a time limit for use; a charge section configured to have a function of charging a battery section furnished in a connected device; and a control section configured to have a function of determining whether or not to transmit the time-limited content based on the time limit information and on received information about an expected time period during which the battery section can sustain a counting operation of the connected device; wherein the control section transmits the content if the expected time period is determined to be longer than the time limit on the content.

According to a further embodiment, there is provided a memory system including: a host device; and a memory device configured to be communicable with the host device; the host device including: a first storage section configured to store time limit information and a content with a time limit for use; a charge section configured to have a function of charging a battery section furnished in the memory device; and a first control section configured to have a function of determining whether or not to transmit the time-limited content based on the time limit information and on information about an expected time period during which the battery section can sustain a counting operation of the memory device; wherein the first control section transmits the content if the expected time period is determined to be longer than the time limit on the content; the memory device including: a second storage section configured to store a content with a time limit for use; an elapsed time counting section configured to count the time limit; a battery section configured to be supplied with power from the charge section of the host device accessing the time-limited content so as to be charged with power for operating the elapsed time counting section; and a second control section configured to include a function of determining the expected time period during which the battery section can sustain the elapsed time counting section operating to count the time limit.

According to the present embodiments as outlined above, it is possible to implement a system of managing use time limit information unfailingly using a minimum battery facility.

Additional features and advantages are described herein, and will be apparent from the following Detailed Description and the figures.

### BRIEF DESCRIPTION OF THE FIGURES

FIG. 1 is a schematic view showing an overall configuration of a memory system according to an embodiment;

FIG. 2 is a block diagram showing a structure of major components in a memory device according to an embodiment;

FIG. 3 is a block diagram showing a structure of major components in a host device according to an embodiment;

FIG. 4 is a flowchart explanatory of a basic communication sequence between the host device and the memory device as embodiments;

FIG. 5 is a schematic diagram explanatory of the basic communication sequence between the host device and the memory device as the embodiments;

FIG. 6 is a schematic diagram explanatory of a communication sequence between the host device and the memory device, with the host device functioning as a recorder;

FIG. 7 is a schematic diagram explanatory of a communication sequence between the host device and the memory device, with the host device functioning as a reproduction player;

FIG. 8 is a schematic diagram explanatory of a communication sequence between the host device and the memory device, with the host device functioning as a recorder and with the memory device having an elapsed time counting section inside serving as a secure countdown timer; and

FIG. 9 is a schematic diagram explanatory of a communication sequence between the host device and the memory device, with the host device functioning as a reproduction player and with the memory device having its elapsed time counting section serving as a secure countdown timer.

### DETAILED DESCRIPTION

Embodiments will now be described in reference to the accompanying drawings. The description will be given under the following headings:

1. Overall structure of the memory system as a whole;

2. Typical structure of the major components in the memory device;

3. Typical structure of the major components in the host device; and

4. Communication sequences between the host device and the memory device.

<1. Overall Structure of the Memory System as a Whole>

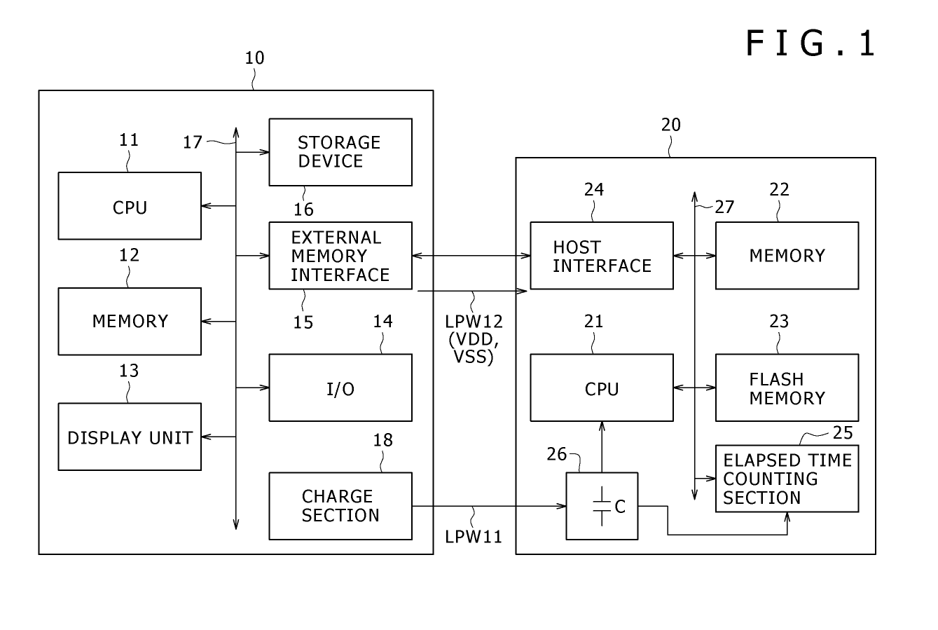

FIG. 1 is a schematic view showing an overall configuration of a memory system according to an embodiment.

As shown in FIG. 1, this memory system has as its major components a host device 10 and a memory device 20 that can be removably attached to the host device 10. In this embodiment, the memory device 20 contains a flash memory that functions as a nonvolatile memory.

The memory system of this embodiment is configured to manage the viewing time limits on DRM (Digital Rights Management)-compliant contents such as rental videos subject to time limits for use (or simply the time limit).

In this embodiment, the memory device 20 is capable of recording DRM-compliant time-limited contents.

The memory device 20 has an elapsed time counting section and a battery section. The elapsed time counting section such as a counter counts a reliable elapsed time for use in managing the determination to permit reproduction of a DRM-compliant time-limited content. The battery section is charged with power for operating the elapsed time counting section.

The memory device 20 also has a control section that can determine the service life of the battery section (a time period during which power can be supplied), i.e., an expected time period during which the operation of the elapsed time counting section (such as a counter) can be sustained.

The host device 10 has a charge section that electrically charges the battery section of the memory device 20.

The host device 10 also has a control section that can determine whether or not to transfer a given content based on expected time information constituted by service life information about the battery section and on the time limits for use on DRM-compliant contents. The control section transfers a time-limited content only if the service life of the battery section is determined to be longer than the time limit on that content for use.

What follows are explanations of the specific components and their functions in the memory device 20 and host device 10.

The host device 10 is composed of an electronic apparatus such as a personal computer (PC) capable of communicating with the memory device 20.

The host device 10 includes a CPU 11 that serves as a first control section, a memory 12, a display unit 13, an input/output (I/O) section 14, and an external memory interface (I/F) 15.

The host device 10 also includes a storage device 16 that stores DRM-compliant time-limited contents and time limit information.

The CPU 11 is interconnected with the memory 12, display unit 13, I/O section 14, external memory interface 15, and storage device 16 via a bus 17.

The memory 12 contains a ROM for storing programs and a RAM or the like serving as a working memory. The external memory interface 15 exchanges data with the memory device 20 in accordance with control commands from the CPU 11.

Also, the host device 10 has a charge section 18 that electrically charges the battery section furnished in the memory device 20 being connected with the host device 10.

The charge section 18 is basically configured to constitute a power supply line LPW11 or the like that charges solely the battery section as part of the memory device 20 being connected.

The host device 10 is configured to constitute a power supply line LPW12 which is different from the power supply line or the like for the charge section 18 and which serves as a main power source to the memory device 20.

The memory device 20 has a CPU 21 that serves as a second control section, a memory 22, a flash memory 23 that services as a second storage section, a host interface 24, an elapsed time counting section 25, and a battery section 26.

The CPU 21 is interconnected with the memory 22, flash memory 23, host interface 24, and elapsed time counting section 25 via a bus 27.

The memory 22 contains a ROM for storing programs and a RAM or the like serving as a working memory.

The flash memory 23 functions as the second storage device and is constituted by a NOR type or a NAND type flash memory (nonvolatile memory).

The host interface 24 exchanges data with the host device 10 in accordance with control commands from the CPU 21.

<2. Typical Structure of the Major Components in the Memory Device>

A more detailed structure of the memory device 20 is explained first.

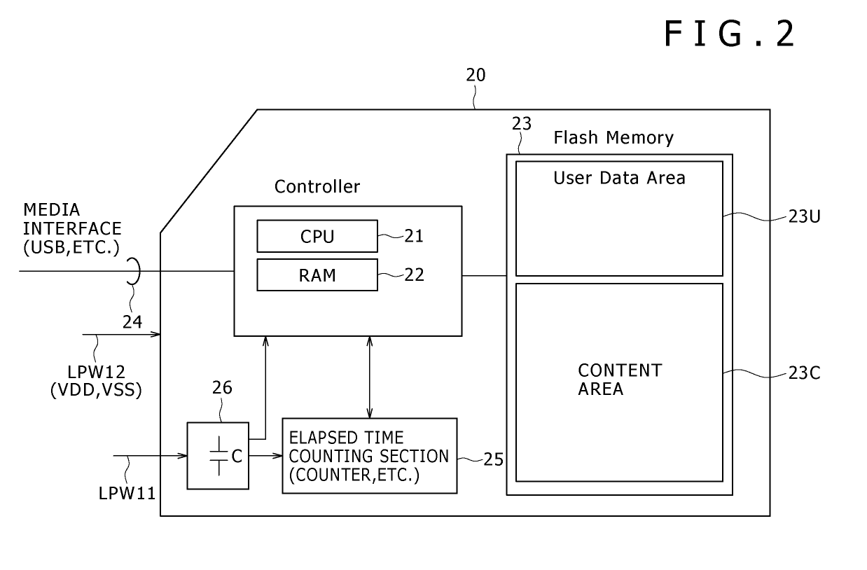

FIG. 2 is a block diagram showing a typical structure of the major components making up the memory device 20 included in FIG. 1.

As shown in FIG. 2, the memory device 20 is typically a plate-like or stick-like memory card. When attached to the host device 10, the memory device 20 is accessed thereby for data read and write operations.

The memory device 20 shown in FIG. 2 includes the flash memory 23 that serves as the second storage device for storing time-limited contents and the elapsed time counting section 25 that counts time limits.

Also, the memory device 20 includes the battery section 26 charged by the host device 10 with power for operating the elapsed time counting section 25, the host device 10 acting as an external device that accesses time-limited contents in the memory.

The memory device 20 further includes the memory (RAM) 22, and the CPU 21 (second control section) having the function of determining the expected time period during which the counting operation of the elapsed time counting section 25 can be sustained by the battery section 26. That is, in the memory device 20 of this embodiment, the CPU 21 serving as the second control section can determine a minimum guaranteed service live of the battery section (i.e., battery life).

In the memory device 20 of FIG. 2, the elapsed time counting section 25 operates only from the power accumulated in the battery section 26.

Also in the memory device 20 of FIG. 2, the CPU 21, memory 22, and flash memory 23 with the exception of the elapsed time counting section 25 operate from the main power source supplied by the host device 10.

The flash memory 23 in the memory device 20 of this embodiment is partitioned into a user data area 23U and a content area 23C. The user data area 23U is an area to and from which user data is written and read. The content area 23C is an area that stores time-limited contents.

The content area 23C may also accommodate information about use conditions including time limits, among others.

The elapsed time counting section 25 operates only from the power accumulated in the battery section 26 as described above.

The elapsed time counting section 25 can be set by the CPU 21 to a time limit on a time-limited content recorded (stored) in the content area 23C of the flash memory 23, in accordance with setting instructions from the host device 10.

The following are some of the methods that can be adopted for describing the time limits on content use:

A first method involves describing an absolute time of a given time limit that can be compared with a secure clock or an anti-rollback clock.

A second method involves utilizing a threshold value of a secure count (e.g., acceptable if smaller than 24×60×60).

A third method involves determining a time-out based on a secure count without describing any values.

The elapsed time counting section 25 designed reliably to manage the determination to permit reproduction of DRM-compliant time-limited contents references a protocol protected against users' intervention to alter values. Any one of the following arrangements may be adopted as the elapsed time counting section 25:

First, a secure clock may be adopted. The secure clock is designed to return a time of day that is not altered or manipulated by the user. Once altered or manipulated in any way, which is not supposed to occur, the secure clock ceases to be secure and becomes an ordinary clock.

Secondly, an anti-rollback clock may be adopted. The anti-rollback clock returns a time of day that cannot be rolled back by the user.

Thirdly, a secure counter value may be adopted. A secure counter may be used to return a timer value derived from count-up or countdown operations that cannot be altered or manipulated by the user.

Fourthly, a time-out based on a secure count may be adopted. This arrangement involves continuously performing counting operations based on a set value and returning a flag indicative of whether or not a time-out is reached.

As the battery section 26 for allowing the elapsed time counting section 25 to function, it is possible to adopt a facility that is electrically charged when connected to the host device 10. The facility may be a rechargeable battery, a capacitor, or a contraption that utilizes a flywheel, a flat spiral spring, etc., to accumulate electrical power in the form of mechanical energy. A rechargeable battery or a capacitor of a film type may be adopted.

As a protocol applicable to the CPU 21 that determines the service life of the battery section 26, i.e., the expected time period during which the operation of the elapsed time counting section 25 can be sustained, it is possible to adopt any one of the methods for indicating a minimum number of days the battery will last using either a value or a flag. Some of the methods that may be adopted are as follows:

A first method involves transmitting to the host device 10 a value of, say, 10 if the battery section 26 is determined to last at least 10 days.

A second method involves assigning an ID to status of the battery section (rechargeable battery) that will last at least, say, 14 days and returning that ID.

A third method involves giving a response of either “1” or “0” upon receipt of a query of whether there is a battery that will last at least a specified number (n) of days.

It is also possible to include the following facilities:

For example, a suitable protocol may be adopted for setting or updating the elapsed time counting section 25. Under such a protocol protected against manipulations, the elapsed time counting section 25 may be set to a value or updated by a host device for device recording purposes or the like. The use of this facility is not mandatory, since the time of day may also be acquired by a built-in facility, as will be explained below.

A built-in facility may be adopted to acquire, set, or update a secure time of day. This is a facility that receives radio waves or accesses networks to acquire the secure time of day. However, the facility is not guaranteed to operate effectively at all times.

It is also possible to utilize a solar cell, a wireless power supply apparatus, a thermocouple, or a mechanical power generator as an auxiliary power source.

The CPU 21 serving as the second control section of the memory device 20 includes the function of communicating with the host device 10.

Upon receipt of a request for power duration specification information from the host device 10, the CPU 21 transmits to the host device 10 information about an expected time period during which the counting operation can be sustained.

The CPU 21 receives a time-limited content from the host device 10 in response to the expected time period information having been transmitted. The CPU 21 then writes the received time-limited content to the content area 23C in the flash memory 23.

If the elapsed time counting section 25 can be set by a restricted host device 10 to a time limit for content use, the CPU 21 can perform the following controls:

Upon receipt of the request for power duration specification information from the host device 10, the CPU 21 transmits to the host device 10 the expected time period during which the counting operation can be sustained.

Given an instruction to set a time limit from the host device 10 in response to the expected time period information having been transmitted, the CPU 21 sets the time limit accordingly and issues a setting complete notification to the host device 10.

On receiving a time-limited content from the host device 10 in response to the setting complete notification, the CPU 21 records the received time-limited content to the content area 23C in the flash memory 23.

If information about use conditions including a time limit is recorded in the content area 23C of the flash memory 23, the CPU 21 can exercise the following controls:

Upon receipt of a request for use condition information, the CPU 21 transmits the use condition information which is held in the content area 23C and which includes the time limit to the host device 10 acting as a reproduction device.

After transmitting the use condition information, the CPU 21 requests time limit information (e.g., secure clock) for time limit determination.

On receiving the time limit information in response to the request, the CPU 21 verifies that the time limit has yet to expire, reads the time-limited content from the content area 23C, and transmits the retrieved time-limited content to the host device 10.

<3. Typical Structure of the Major Components in the Host Device>

A more detailed structure of the host device 10 is explained below.

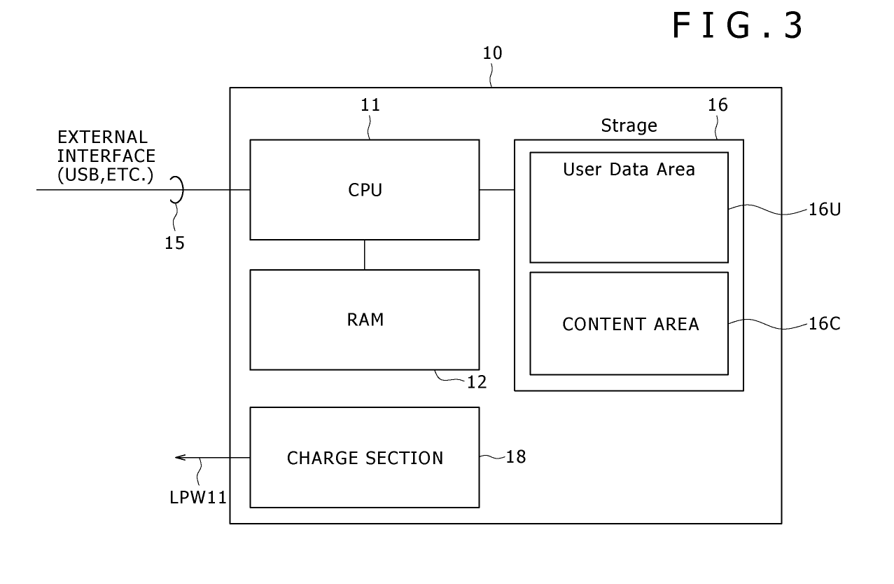

FIG. 3 is a block diagram showing a typical structure of the major components in the host device 10 included in FIG. 1.

The host device 10 in FIG. 3 is shown to include the CPU 11, memory 12 (RAM), storage device 16, and charge section 18.

The storage device 16 in the host device 10 is partitioned into a user area 16U and a content area 16C. The user area 16U is an area to and from which user data is written and read. The content area 16C is an area that stores time-limited contents and time limit information.

The charge section 18 has the function of electrically charging the battery section 26 in the memory device 20 via the power supply line LPW11 when the memory device 20 is connected to the host device 10.

The CPU 11 serving as the first control section of the host device 10 includes the function of determining whether or not to transmit a given content based on the expected time period information sent from the memory device 20 as well as on the time limit information in the content area 16C, the expected time period being a time period during which the counting operation can be sustained by the battery section 26.

The CPU 11 has the function of transmitting the content of interest to the memory device 20 if it is determined that the expected time period is longer than the time limit on that content.

The CPU 11 transmits a request for power duration specification information to the memory device 20. On receiving expected time period information about counting operation duration in response to the request for power duration specification information, the CPU 11 verifies whether the expected time period information is equal to or longer than the time limit on the content.

If the verification above is successful, then the CPU 11 transmits the time-limited content to the memory 20 in response to the expected time period information.

Also, when the CPU 11 transmits the request for power duration specification information to the memory device 20 and receives in return the expected time period information about counting operation duration, the CPU 11 may transmit to the memory 20 an instruction to set a time limit on the content of interest.

The CPU 11 has the function of transmitting the time-limited content to the memory device 20 upon receipt of a setting complete notification from the memory device 20 in response to the instruction to set the time limit.

The host device 10 can also function as a recorder that records time-limited contents to the memory device 20 serving as a storage device.

In this case, too, with the memory device 20 connected, the host device 10 causes the charge section 18 to charge electrically the battery section 26 of the memory device 20, verifies whether the time-limited content of interest is allowed to be recorded, and writes the content to the memory device 20 if the verification is successful.

As explained above, the charge section 18 is configured to charge the battery or capacitor electrically or to wind up the spiral spring of a suitable arrangement to accumulate energy when the memory device 20 is connected.

The host device 10 may be configured to selectively carry out one of such alternatives as whether or not to transfer a given content and whether or not to query the user, through the use of the service life of the battery section and the time limits on DRM-compliant contents.

As described above, if it is determined that the service life of the battery section 26 is longer than the time limit on a given content, the host device 10 transmits (transfers) the content. If the service life of the battery section 26 is determined to be shorter than the time limit in question, the host device 10 may perform the following operations:

The CPU 11 of the host device 10 causes the display unit 13 to display an error message regarding the problems upon transmission, and does not transfer the content.

The CPU 11 then warns of the problems upon transmission, and queries whether or not to proceed with the transmission.

Alternatively, the CPU 11 may not give any warning or like indications and not transfer the content.

The host device 10 may also have the following functions:

The host device 10 may have the function of setting or updating the elapsed time counting section 25 on the part of the memory device 20. If the memory device 20 complies with a suitable protocol for setting or updating the elapsed time counting section 25, then this function of the host device 10 maintains the elapsed time counting section 25.

Alternatively, this function of the host device 10 may be formed integrally with a host device for reproduction purposes of the memory device 20 acting as a storage device, as will be explained below.

The host device 10 may also function as a player that reproduces time-limited contents held in the memory device 20 acting as the storage device.

In this case, the host device 10 may determine whether or not to permit reproduction of DRM-compliant time-limited contents.

It is determined whether the time limit on a given content has yet to expire or has expired, based on the combination of that time limit with the count value from the elapsed time counting section 25. The determining facility may be implemented as follows:

Where the absolute time of the time limit on the content of interest is recorded, that absolute time is compared with a secure clock or an anti-rollback clock to determine whether the time limit in question has expired. The comparison may be carried out alternatively on the side of the memory device 20.

The value on the elapsed time counting section 25 (e.g., counter) is compared with a threshold value of the recorded time limits to determine whether the time limit of interest has expired. The comparison may be carried out alternatively on the side of the memory device 20.

If the counter value is other than zero in the preceding case, then it is determined that the content of interest can be reproduced.

Once the DRM-compliant time-limited content is allowed to be reproduced, the reproduction of that content is carried out.

<4. Communication Sequences Between the Host Device and the Memory Device>

What follows is an explanation of the communication sequences between the host device 10 and the memory device 20 as embodiments.

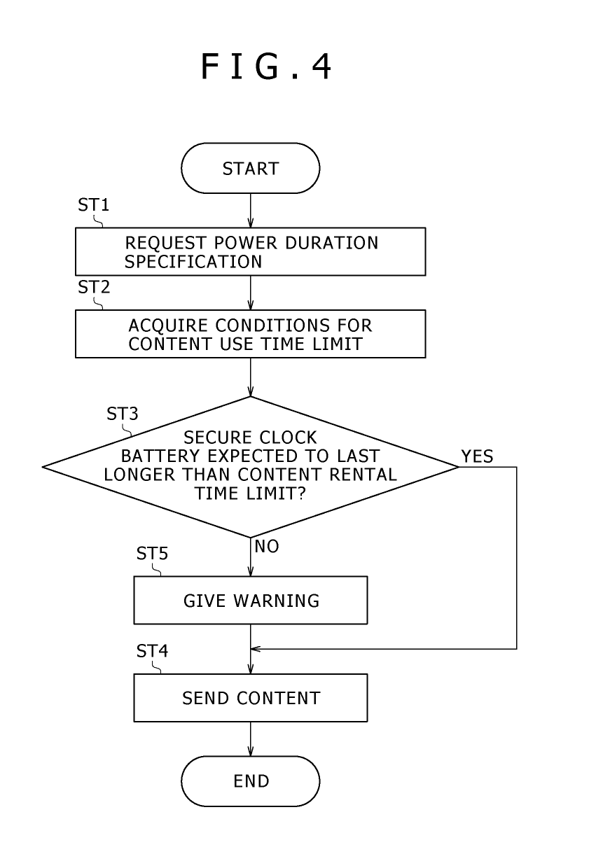

FIG. 4 is a flowchart explanatory of a basic communication sequence between the host device 10 and the memory device 20 as the embodiments.

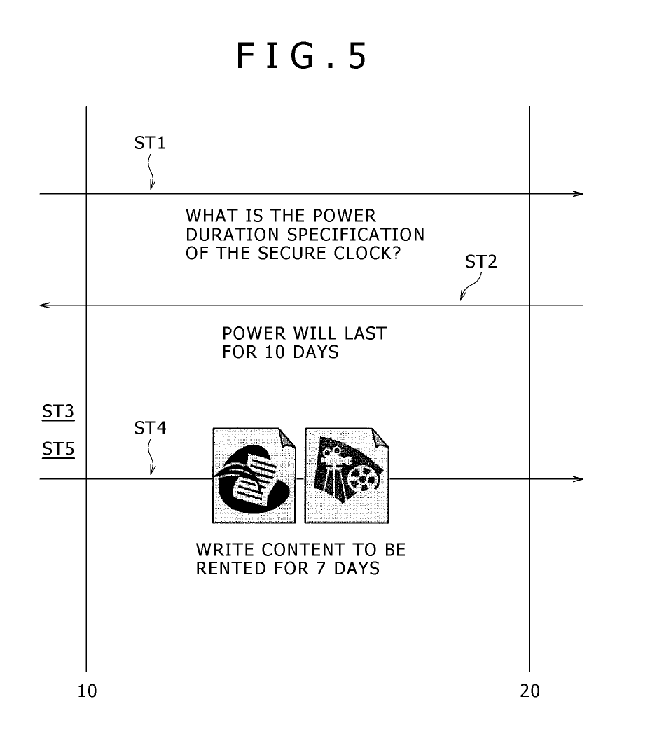

FIG. 5 is a schematic diagram explanatory of the basic communication sequence between the host device 10 and the memory device 20 as the embodiments.

In the examples that follow, the elapsed time counting section 25 will be explained as a secure clock.

[Step ST1]

In step ST1, the host device 10 transmits a request for power duration specification information to the memory device 20 being connected.

[Step ST2]

In step ST2, on receiving the request for power duration specification information from the host device 10, the memory device 20 transmits to the host device 10 information about an expected time period during which the counting operation can be sustained, such as information indicating that the counting operation can last, say, 10 days.

[Step ST3]

In step ST3, on receiving the expected time period information about counting operation duration in response to the request for power duration specification information, the host device 10 verifies whether the expected time period information is equal to or longer than the time limit on a given content for use.

In other words, the CPU 11 of the host device 10 determines whether the service life of the battery section 26 serving as the battery for the secure clock will last longer than the rental time limit of the content.

[Step ST4]

In step ST4, if the service life of the battery section 26 acting as the battery for the secure clock is determined to be longer than the rental time limit on the content, the CPU 11 of the host device 10 transmits the time-limited content to the memory device 20.

Upon receipt of the time-limited content from the host device 10 in response to the expected time period information having been transmitted, the CPU 21 of the memory device 20 writes the received time-limited content to the content area 23C in the flash memory 23.

[Step ST5]

In step ST5, if the service life of the battery section 26 acting as the battery for the secure clock is not determined to be longer than the rental time limit on the content, then the CPU 11 of the host device 10 issues a warning about the problems upon transmission.

The CPU 11 then performs appropriate processes such as a process of querying whether or not to proceed with the transmission.

Explained below is the communication sequence between the host device 10 and the memory device 20 as the embodiments, with the host device 10 acting as a recorder.

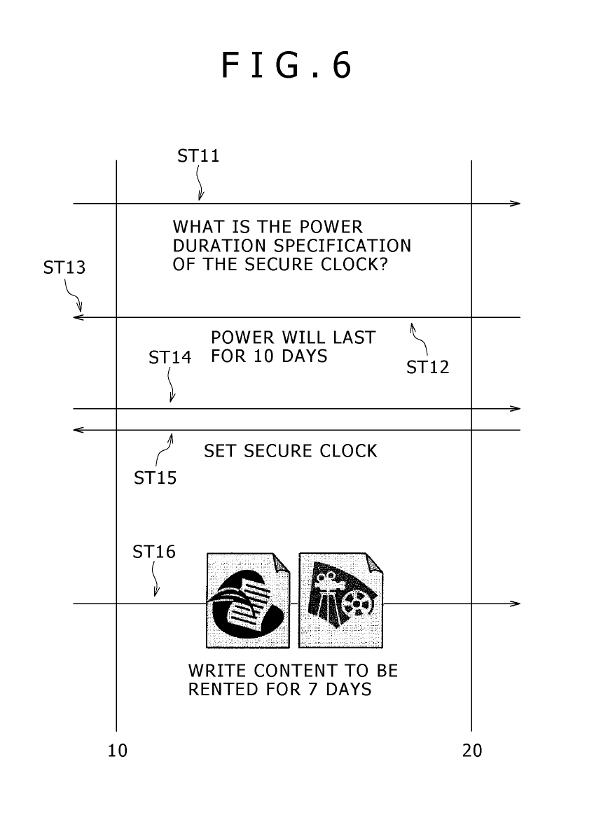

FIG. 6 is a schematic diagram explanatory of a typical communication sequence between the host device 10 and the memory device 20, with the host device 10 functioning as the recorder.

[Step ST11]

In step ST11, the host device 10 transmits a request for power duration specification information to the memory device 20 being connected.

[Step ST12]

In step ST12, on receiving the request for power duration specification information from the host device 10, the memory device 20 transmits to the host device 10 information about an expected time period during which the counting operation can be sustained, such as information indicating that the counting operation can last, say, 10 days.

[Step ST13]

In step ST13, on receiving the expected time period information about counting operation duration in response to the request for power duration specification information, the host device 10 verifies whether the expected time period information is equal to or longer than the time limit on the content of interest.

In other words, the CPU 11 of the host device 10 determines whether the service life of the battery section 26 serving as the battery for the secure clock will last longer than the rental time limit of the content.

[Step ST14]

If, for example, in step ST13 the service life of the battery section 26 acting as the battery for the secure clock is determined to be longer than the rental time limit on the content, the CPU 11 of the host device 10 in step ST14 carries out the following process:

In step ST14, the CPU 11 of the host device 10 transmits to the memory device 20 an instruction to set a time limit on the content for use.

[Step ST15]

In step ST15, the CPU 21 of the memory device 20 receives from the host device 10 the instruction to set the time limit in response to the expected time period information having been transmitted. In return, the CPU 21 sets the time limit accordingly and issues a setting complete notification to the host device 10.

[Step ST16]

In step ST16, upon receipt of the setting complete notification from the host device 10 in response to the instruction to set the time limit, the CPU 11 of the host device 10 transmits the time-limited content to the memory device 20.

On receiving the time-limited content from the host device 10 in response to the setting complete notification described above, the CPU 21 of the memory device 20 writes the received time-limited content to the content area 23C in the flash memory 23.

For example, in step ST13, the CPU 11 of the host device 10 may determine that the service life of the battery section 26 serving as the battery for the secure clock is not longer than the rental time limit of the content. If that happens, the CPU 12 issues a warning about the problems upon transmission, as was the case in FIGS. 4 and 5.

The CPU 11 then performs appropriate processes such as a process of querying whether or not to proceed with the transmission.

Explained below is the communication sequence between the host device 10 and the memory device 20 as the embodiments, with the host device 10 acting as a reproduction player.

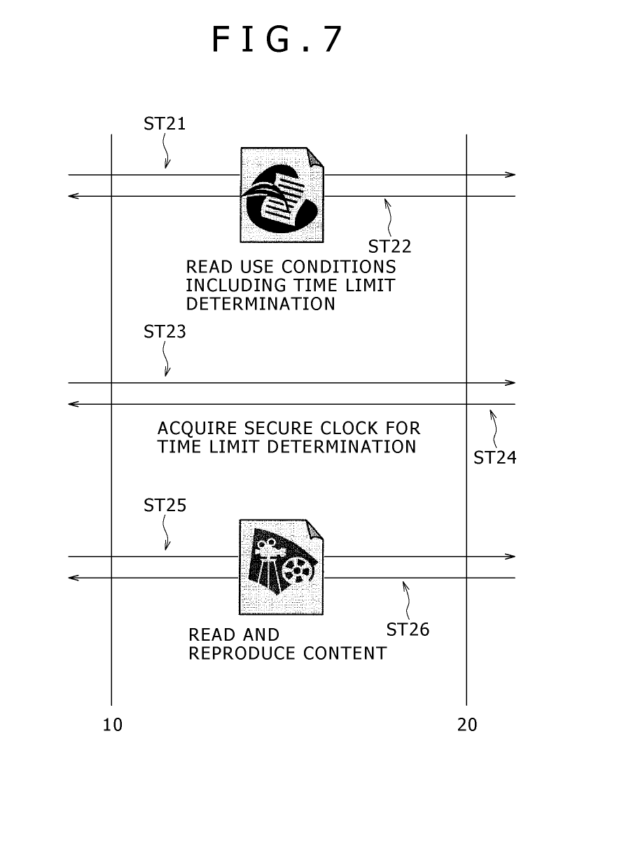

FIG. 7 is a schematic diagram explanatory of a typical communication sequence between the host device 10 and the memory device 20, with the host device 10 functioning as the reproduction player.

[Step ST21]

In step ST21, the host device 10 transmits to the memory device 20 a request to read use conditions including a time limit.

[Step ST22]

In step ST22, in response to the request for use condition retrieval, the memory device 20 reads the use conditions including the time limit from the content area 23C of the flash memory 23 and transmits the retrieved use conditions to the host device 10.

[Step ST23]

In step ST23, the host device 10 transmits to the memory device 20 a request for transmission of a secure clock for time limit determination.

[Step ST24]

In step ST24, the memory device 20 transmits the secure clock to the host device 10 in response to the request for secure clock transmission.

[Step ST25]

In step ST25, the host device 10 determines whether or not the time limit on the memory device 20 has yet to expire according to the secure clock. If it is determined that the time limit has yet to expire, the host device 10 transmits a request for content reproduction to the memory device 20.

[Step ST26]

In step ST26, the memory device 20 reads the time-limited content from the content area 23C and transmits the retrieved time-limited content to the host device 10.

The host device 10 then reproduces the retrieved content.

What follows is an explanation of the communication sequence between the host device 10 and the memory device 20 as the embodiments, with the host device 10 acting as a recorder and with the elapsed time counting section 25 serving as a secure countdown timer.

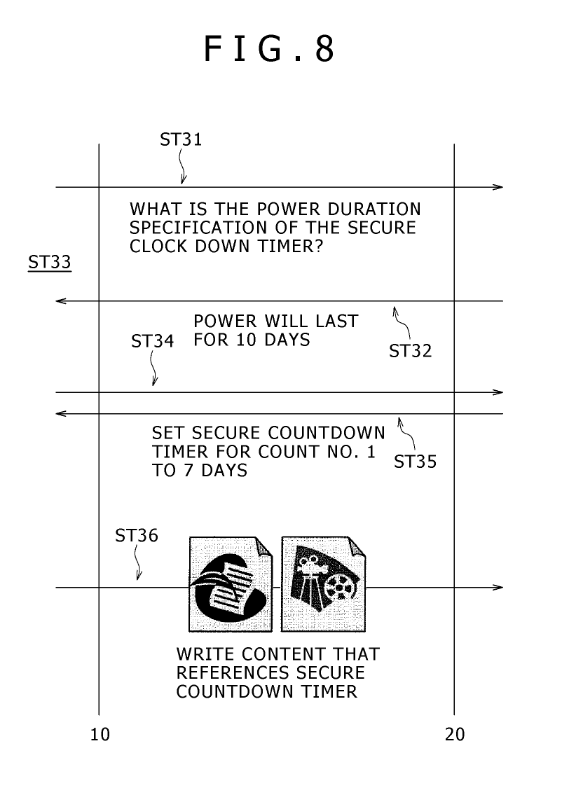

FIG. 8 is a schematic diagram explanatory of a typical communication sequence between the host device 10 and the memory device 20, with the host device 10 functioning as the recorder and with the elapsed time counting section 25 operating as the secure countdown timer.

[Step ST31]

In step ST31, the host device 10 transmits a request for power duration specification information about a secure countdown timer to the memory device 20 being connected.

[Step ST32]

In step ST32, upon receipt of the request for power duration specification information about the secure countdown timer from the host device 10, the memory device 20 transmits to the host device 10 information about an expected time period during which the counting operation can be sustained, such as information indicating that the counting operation can last, say, 10 days.

[Step ST33]

In step ST33, on receiving the expected time period information about counting operation duration in response to the request for power duration specification information, the host device 10 verifies whether the expected time period information is equal to or longer than the time limit on the content of interest.

In other words, the CPU 11 of the host device 10 determines whether the service life of the battery section 26 serving as the battery for the secure clock will last longer than the rental time limit of the content.

[Step ST34]

If, for example, in step ST33 the service life of the battery section 26 acting as the battery for the secure clock is determined to be longer than the rental time limit on the content, the CPU 11 of the host device 10 in step ST34 carries out the following process:

In step ST34, the CPU 11 of the host device 10 transmits to the memory device 20 an instruction to set the secure countdown timer for content No. 1 to, say, seven days.

[Step ST35]

In step ST35, upon receipt of the instruction to set the time limit from the host device 10 in response to the expected time period information having been transmitted, the memory device 20 sets the secure countdown timer accordingly to seven days and issues a setting complete notification to the host device 10.

[Step ST36]

In step ST36, on receiving the setting complete notification from the memory device 20 in response to the instruction to set the time limit, the CPU 11 of the host device 10 transmits to the memory device 20 the time-limited content that references the secure countdown timer.

In the manner described above, the CPU 21 of the memory device 20 receives the time-limited content referencing the secure countdown timer from the host device 10 in response to the setting complete notification. The CPU 11 proceeds to write the received time-limited content to the content area 23C.

For example, in step ST33, the CPU 11 of the host device 10 may determine that the service life of the battery section 26 serving as the battery for the secure clock is not longer than the rental time limit of the content. If that happens, the CPU 11 issues a warning about the problems upon transmission, as was the case in FIGS. 4 and 5.

The CPU 11 then performs appropriate processes such as a process of querying whether or not to proceed with the transmission.

What follows is an explanation of the communication sequence between the host device 10 and the memory device 20 as the embodiments, with the host device 10 acting as a reproduction player and with the elapsed time counting section 25 serving as a secure countdown timer.

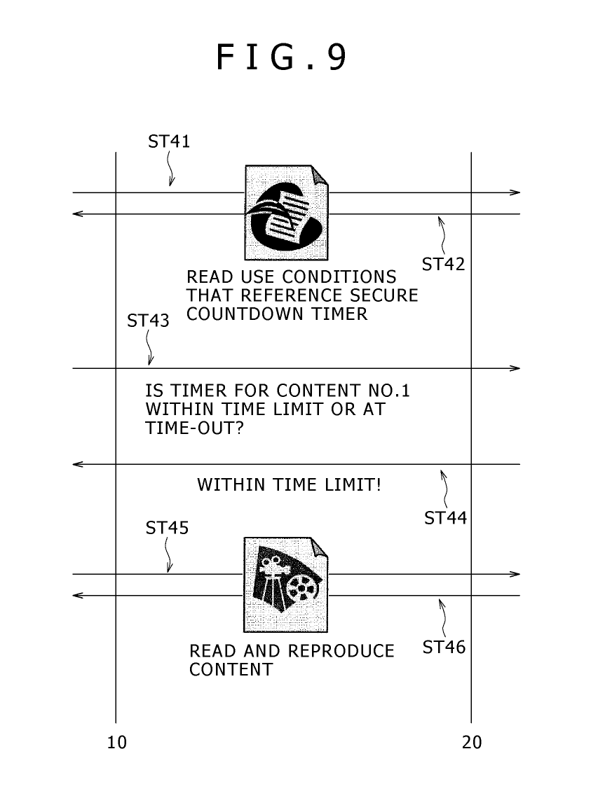

FIG. 9 is a schematic diagram explanatory of a typical communication sequence between the host device 10 and the memory device 20, with the host device 10 functioning as the reproduction player and with the elapsed time counting section 25 operating as the secure countdown timer.

[Step ST41]

In step ST41, the host device 10 transmits to the memory device 20 a request to read use conditions that reference the securer countdown timer.

[Step ST42]

In step ST42, in response to the request for use condition retrieval, the memory device 20 reads the use conditions referencing the secure countdown timer from the content area 23C of the flash memory 23, and transmits the retrieved use conditions to the host device 10.

[Step ST43]

In step ST43, the host device 10 transmits to the memory device 20 a request to determine whether the secure countdown timer for content No. 1 is within the time limit or has reached a time-out.

[Step ST44]

In step ST44, the memory device 20 determines that, for example, the secure countdown timer for content No. 1 is within the time limit and notifies the host device 10 to that effect.

[Step ST45]

In step ST45, after being notified that the secure countdown timer is within the time limit, the host device 10 transmits a request for content reproduction to the memory device 20.

[Step ST46]

In step ST46, the memory device 20 reads the time-limited content from the content area 23C and transmits the retrieved time-limited content to the host device 10.

In turn, the host device 10 reproduces the content that was retrieved from the memory device 20.

According to the embodiments described above, products of such services as video rental commerce each equipped with a battery section with a very short service life (e.g., 10 days) bordering on the typical time limits (e.g., for eight days and seven nights) on these products can still be offered to customers without incurring the risk of the power for a secure clock being exhausted before a time-out is reached on the contents being rented.

As a result, where a secure clock device is provided to reproduction players incapable of acquiring a reliable time of day due to their inability to access networks for example, it is possible to implement a scheme of making a comparison between the time limit on the content written to a storage device integral with the secure clock device on the one hand, and the service life of a battery arrangement for powering the secure clock device on the other hand, whereby time-limit-based business operations are run securely.

In such a manner, the business of handling rental video type contents can be run securely using a minimum battery facility because the battery facility can be made significantly smaller in size and less expensive than before.

The methods explained above in detail may be formed into a program or programs reflecting the above-described steps and may be executed by computers such as a CPU.

The above-mentioned program or programs may be stored on such recording media as semiconductor memories, magnetic disks, optical disks and floppy (registered trademark) disks. The programs may be accessed and executed by a computer loaded with a piece of such recording media carrying the programs.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory device comprising:
a storage section configured to store a content with a time limit for use;
an elapsed time counting section configured to count said time limit;
a battery section configured to be supplied with power from an external device accessing the time-limited content so as to be charged with power for operating said elapsed time counting section; and
a control section configured to include a function of determining an expected time period during which said battery section can sustain said elapsed time counting section operating to count said time limit.

2. The memory device according to claim 1, wherein, upon receipt of a request for power duration specification information, said control section transmits information about the expected time period during which the counting operation can be sustained; and
upon receipt of a content with a time limit for use in response to the expected time period information having been transmitted, said control section stores the received time-limited content into said storage section.

3. The memory device according to claim 1, wherein said elapsed time counting section is capable of being set by a restricted external device to a time limit for use;
upon receipt of a request for power duration specification information, said control section transmits information about the expected time period during which the counting operation can be sustained;
upon receipt of an instruction to set a time limit for use in response to the expected time period information having been transmitted, said control section sets said time limit in accordance with the setting instruction and transmits a setting complete notification upon completion of the setting; and
upon receipt of a content with a time limit for use in response to said setting complete notification, said control section stores the received time-limited content into said storage section.

4. The memory device according to claim 3, wherein said storage section stores information about use conditions;
upon receipt of a request for use condition information, said control section transmits said use condition information;
said control section conducts communications to acquire time limit information by which to determine the time limit for use in response to the transmitted use condition information; and
upon verifying that said time limit has yet to expire according to the acquired time limit information, said control section reads the time-limited content from said storage section and transmits the retrieved time-limited content.

5. A host device comprising:
a storage section configured to store time limit information and a content with a time limit for use;
a charge section configured to have a function of charging a battery section furnished in a connected device; and
a control section configured to have a function of determining whether or not to transmit the time-limited content based on said time limit information and on received information about an expected time period during which said battery section can sustain a counting operation of said connected device;
wherein said control section transmits said content if said expected time period is determined to be longer than said time limit on said content.

6. The host device according to claim 5, wherein said control section transmits a request for power duration specification information;
upon receipt of the information about the expected time period during which the counting operation can be sustained in response to said request for power duration specification information, said control section verifies that said expected time period is equal to or longer than said time limit on said content; and
upon successful conclusion of the verification, said control section transmits said time-limited content in response to the expected time period information.

7. The host device according to claim 5, wherein, upon receipt of the information about the expected time period during which the counting operation can be sustained in response to a transmitted request for power duration specification information, said control section transmits an instruction to set a time limit for use on a content; and
upon receipt of a setting complete notification in response to said instruction to set said time limit, said control section transmits said time-limited content.

8. A memory system comprising:
a host device; and
a memory device configured to be communicable with said host device;
said host device including
a first storage section configured to store time limit information and a content with a time limit for use,
a charge section configured to have a function of charging a battery section furnished in said memory device, and
a first control section configured to have a function of determining whether or not to transmit the time-limited content based on said time limit information and on information about an expected time period during which said battery section can sustain a counting operation of said memory device,
said first control section transmits said content if said expected time period is determined to be longer than said time limit on said content,
said memory device including
a second storage section configured to store a content with a time limit for use,
an elapsed time counting section configured to count said time limit,
a battery section configured to be supplied with power from said charge section of said host device accessing the time-limited content so as to be charged with power for operating said elapsed time counting section, and
a second control section configured to include a function of determining said expected time period during which said battery section can sustain said elapsed time counting section operating to count said time limit.

9. The memory system according to claim 8, wherein said first control section transmits a request for power duration specification information;
upon receipt of the information about the expected time period during which the counting operation can be sustained in response to said request for power duration specification information, said first control section verifies that said expected time period is equal to or longer than said time limit on said content;
upon successful conclusion of the verification, said first control section transmits said time-limited content in response to the expected time period information;
upon receipt of said request for power duration specification information from said host device, said second control section transmits the information about the expected time period during which the counting operation can be sustained to said host device; and
upon receipt of a content with a time limit for use from said host device in response to said expected time period information having been transmitted, said second control section stores the received time-limited content into said second storage section.

10. The memory system according to claim 8, wherein, upon receipt of the information about the expected time period during which the counting operation can be sustained in response to a request for power duration specification information transmitted to said memory device, said first control section transmits an instruction to set a time limit for use on a content to said memory device;
upon receipt of a setting complete notification in response to said instruction to set said time limit, said first control section transmits said time-limited content to said memory device;
said elapsed time counting section of said memory device is capable of being set by said host device to a time limit for use;
upon receipt of a request for power duration specification information from said host device, said second control section transmits information about the expected time period during which the counting operation can be sustained;
upon receipt of an instruction to set a time limit for use from said host device in response to the expected time period information having been transmitted, said second control section sets said time limit in accordance with the setting instruction and transmits a setting complete notification to said host device upon completion of the setting; and
upon receipt of a content with a time limit for use in response to said setting complete notification from said host device, said second control section stores the received time-limited content into said second storage section.

11. The memory system according to claim 10, wherein said second storage section stores information about use conditions;
upon receipt of a request for use condition information from said host device, said second control section transmits said use condition information to said host device;
said second control section requests the time limit information by which to determine the time limit for use following the transmission of said use condition information; and
upon receipt of said time limit information in response to the request, said second control section verifies that said time limit has yet to expire, reads the time-limited content from said second storage section following successful conclusion of the verification, and transmits the retrieved time-limited content to said host device.

12. A memory device comprising:
storage means for storing a content with a time limit for use;
elapsed time counting means for counting said time limit;
battery means for being supplied with power from an external device accessing the time-limited content so as to be charged with power for operating said elapsed time counting means; and
control means for including a function of determining an expected time period during which said battery means can sustain said elapsed time counting means operating to count said time limit.

13. A host device comprising:
storage means for storing time limit information and a content with a time limit for use;
charge means for having a function of charging a battery means furnished in a connected device; and
control means for having a function of determining whether or not to transmit the time-limited content based on said time limit information and on received information about an expected time period during which said battery means can sustain a counting operation of said connected device;
wherein said control means transmits said content if said expected time period is determined to be longer than said time limit on said content.
